(19) United States
(12) Patent Application Publication
(10) Pub. No.: US 2011/0271845 A1
(43) Pub. Date: Nov. 10, 2011

(54) DISPOSABLE COFFEE-BREWING DEVICE

(76) Inventor: Yang Suk Lee, Incheon (KR)

(21) Appl. No.: 13/145,106

(22) PCT Filed: Dec. 11, 2009
(86) PCT No.: PCT/KR2009/007427

§ 371 Date: Jul. 18, 2011

(30) Foreign Application Priority Data
Jan. 16, 2009 (KR) 20-2009-0000582
Jun. 5, 2009 (KR) 20-2009-0007246
Oct. 16, 2009 (KR) 20-2009-0013478

(51) Int. Cl. A47J 31/06

(52) U.S. Cl. 99/295

(57) ABSTRACT

The present invention relates to a disposable coffee-brewing device comprising: a support plate which is coupled to a beverage container such as a cup, and one side of which has an opening; a cylindrical body which protrudes downwardly from the support plate, and has an open top and a lower portion with a stepped portion for accommodating coffee grounds and having a lower end with a brewing aperture to which filtering paper is attached; and an upper sealing cover and a lower sealing cover which are attached to the top of the coffee grounds-accommodating portion and to the bottom of the brewing aperture, respectively, to seal the coffee-grounds-accommodating portion, and which have respective handles. The handle of the upper sealing cover extends toward the upper surface of the support plate, and the handle of the lower sealing cover is formed at one side of the lower sealing cover, farther from the opening and extends to the upper surface of the support plate through the opening. The disposable coffee-brewing device of the present invention tightly seals coffee grounds to maintain the taste and flavor of the coffee and preserve coffee grounds over a long period of time. The disposable coffee-brewing device of the present invention can be used in a significantly convenient manner by simply removing the sealing means thereof and adding hot water directly into the device to prepare brewed coffee. Further, the device of the present invention can be elastically fitted to a beverage cup, and a plurality of the devices of the present invention can be stacked into a layer for easy use and storage.

### TECHNICAL FIELD

The present invention relates to a disposable coffee-brewing device, and more particularly, to a disposable coffee-brewing device which stores coffee in a sealed for a long period of time without any deterioration of quality, and is easy to use and is elastically fitted to a beverage cup and is plurally stacked into a layer for easy use and storage and enables anyone to enjoy coffee wherever and whenever without difficulty.

### BACKGROUND ART

Generally, coffee can be classified into whole coffee beans which are dried, roasted and stored, and ground and brewed with hot water; and instant coffee which is made by extracting the coffee liquid from roasted coffee beans, concentrating and vacuum-drying or free-drying such liquid and by mixing hot water and coffee powder or grounds.

From the general perspective, coffee beans are better than instant coffee in taste and quality as well as in aroma and most people prefer coffee beans to instant coffee. In reality, however, instant coffee is more consumed than coffee beans at the ratio of 8:2.

People prefer coffee beans but drink instant coffee more frequently since brewing coffee is not easy. That is, roasting, grinding and filtering coffee beans takes more than mixing hot water and instant coffee. Also, grinding and filtering coffee beans requires an additional device such as a coffee mate. If such device is not available or in the case of outdoors, it is not easy to enjoy coffee.

Inventions for a disposable coffee brewing device have been disclosed to enable people to enjoy coffee more conveniently in consideration of the foregoing problems.

As an example of the above conventional art, registered utility model No. 20-0267366 discloses an instant coffee brewing set, which includes a plurality of brewing containers containing coffee powder and filters to brew coffee, and brewing rings to place the brewing containers in a beverage cup.

However, the coffee brewing set requires several processes such as installing a filtering paper in a brewing container, connecting the brewing container to the brewing ring, unpacking the packed coffee beans and putting the coffee beans in the brewing container, and therefore it is still inconvenient to use the coffee brewing set.

Patent No. 10-0371558 discloses a disposable coffee-brewing container, which includes a hopper to receive water poured thereinto, a penetration portion which extends from a bottom of the hopper in a certain length, accommodates tea bags packed in accordance with the number of people drinking coffee and serves as a dripper, and a supporter which is detachably attached to a coffee cup from the bottom of the penetration portion.

The foregoing disposable coffee-brewing container is easier to use, but the coffee beans are accommodated in the tea bags without sealing and are exposed to the air for a long time and thus cannot be stored for a long time and the taste and flavor of such coffee may deteriorate.

That is, coffee beans are affected in taste and flavor by oxygen, humidity and heat during storage, and among, others are exposed to oxygen and oxidized. The higher humidity is, the more the coffee is oxidized. As the coffee beans are oxidized, the flavor and taste of the coffee deteriorates and the coffee has bad taste.

Accordingly, what is most important thing for a disposable or portable coffee-brewing container is convenience in use, securing sealing of coffee to preserve taste and flavor of coffee for a long time. Most of conventional coffee-brewing containers including the foregoing related arts failed to ensure convenience in use and sealing of coffee but intended only to improve either convenience in use or the sealing.

The conventional disposable coffee-brewing container is supported by the top of a beverage cup to be stored and used. The conventional disposable coffee-brewing container has a container main body that has a wider top than a top of a beverage cup so that the container main body is stored or used while being placed on the top of the beverage cup, or has a container main body that has a narrower top than a top of the beverage cup so that the container main body is stored or used while being fitted to an internal circumference of the top of the beverage cup.

If the container main body is placed on the top of the beverage cup, the disposable coffee-brewing container may not be stably supported and thus is not stored easily together with the beverage cup and is not easy to use. If the container main body is fitted to the internal circumference of the beverage cup, it is hard to pull out the disposable coffee-brewing container from the beverage cup to drink coffee after brewing the coffee.

### DISCLOSURE

### Technical Problem

The present invention has been made to solve the problems and it is an object of the present invention to provide a disposable coffee-brewing device which ensures sealing of coffee beans to preserve taste and flavor of coffee and stores such coffee for a long time, and enables a user to easily remove a sealing means and drink coffee by only adding hot water.

Another aspect of the present invention is to provide a disposable coffee-brewing device which is stably supported by a beverage cup and is easy to store and use, and is plurally stacked into a layer by fitting two disposable coffee-brewing devices vertically.

### Technical Solution

In order to achieve the object of the present invention,

A disposable coffee-brewing device comprises a support plate which is coupled to a beverage container such as a cup, and one side of which has an opening; a cylindrical body which protrudes downwardly from the support plate, and has an open top and a lower portion with a stepped portion for accommodating coffee grounds and having a lower end with a brewing aperture to which filtering paper is attached; and an upper sealing cover and a lower sealing cover which are attached to the top of the coffee grounds-accommodating portion and to the bottom of the brewing aperture, respectively, to seal the coffee-grounds-accommodating portion, and which have respective handles.

The handle of the upper sealing cover extends toward the upper surface of the support plate, and the handle of the lower sealing cover is formed at one side of the lower sealing cover, farther from the opening and extends to the upper surface of the support plate through the opening. End portions of the handles of the upper and lower sealing covers are attached to each other as a single body.

In order to achieve the object of the present invention, a disposable coffee-brewing device comprises a container main body which has an open top and a coffee grounds-accommodating portion with a stepped portion to accommodate therein coffee grounds in a location down from the open top at a certain distance, and a brewing aperture with a plurality of brewers in a bottom of the coffee grounds-accommodating portion; a filtering paper which is fixed to the top of brewers of the brewing aperture; an upper sealing cover which is attached to an upper step of the coffee grounds-accommodating portion and seals the top of the coffee grounds-accommodating portion and has a handle extending from and formed at one side thereof; and a lower sealing cover which is attached to an upper step of the brewing aperture to be spaced from the filtering paper at a predetermined interval and seals the bottom of the coffee grounds-accommodating portion and has a handle extending from and formed at one side thereof.

An elastic supporter may be bent downwardly from an upper external circumference of the container main body and have a projection formed in an internal surface thereof and be elastically fitted to the top of the beverage container. A cutting portion may be formed at one side of the elastic supporter to circulate air. A container extension portion may extend upwardly in a certain length along an upper section of the container main body.

In order to achieve the object of the present invention, a disposable coffee-brewing device which accommodates and stores coffee grounds in an inside of a container main body having an open top and a lower portion having a brewing aperture to which filtering paper is attached and brews coffee to a beverage container by adding hot water, wherein a fitting supporter is bent downwardly from an upper circumference of the container main body and forms a fitting space portion between an internal surface thereof and an external surface of the container main body to insert the upper surface of the beverage container thereinto and has a step formed in and protruding from an internal surface thereof.

A container extension portion extends in a certain length upwardly from the top of the container main body and has an open top; and a plurality of fitting projections 340 is fitted to an internal circumference of the container extension portion, wherein at least two disposable coffee-brewing devices are stacked into a layer by fitting the fitting projections of the upper disposable coffee-brewing device to an internal circumference of the container extension portion of the lower disposable coffee-brewing device.

An inclination surface may be formed in a lower surface of the fitting projections and the container extension portion may have a curved portion formed in an upper side thereof. The container extension portion may have a diameter corresponding to the size of the container lid to be inserted into and fitted to the container lid of the beverage container. A water indication line may be displayed in an internal circumference of the container extension portion to adjust the quantity of hot water.

### Advantageous Effect

As described above, the disposable coffee-brewing device according to the present invention has the following advantages.

The disposable coffee-brewing device seals a cylindrical body accommodating therein coffee instead of having coffee packed in an additional package, maintains taste and flavor of, and stores, coffee for a long time and a user does not need unpack the package of coffee. Among others, a user may easily remove upper and lower sealing covers at a time and add hot water to the cylindrical body to enjoy coffee. Thus, the disposable coffee-brewing device is easy to use, and stores coffee for a long time and ensures convenience in use.

Further, the disposable coffee-brewing device according to the present invention has the following advantages.

The disposable coffee-brewing device has a fitting supporter formed in a container main body and fitted elastically to a top of a beverage cup, and is detachably attached to the beverage cup without difficulty. As the disposable coffee-brewing device may plurally be stacked into a layer, the entire size may be reduced and the plurality of disposable coffee-brewing devices is stored without difficulty. Accordingly, a plurality of coffee-brewing devices may be manufactured in a set for couples, families and group.

In addition to the effect set forth as above, other specific effects which can be easily derived and expected from the configuration of the present invention may also be included in the effect of the present invention.

### BRIEF DESCRIPTION OF DRAWINGS

FIG. 1 is a perspective view of a disposable coffee-brewing device according to a first exemplary embodiment of the present invention.

FIG. 2 is an exploded perspective view of the disposable coffee-brewing device in FIG. 1.

FIG. 3 is a sectional view of the disposable coffee-brewing device, taken along line “A-A” in FIG. 1.

FIG. 4 is a plan view of a support plate and a cylindrical body according to the first exemplary embodiment of the present invention.

FIGS. 5 to 7 are sectional views of a usage process of the disposable coffee-brewing device according to the first exemplary embodiment of the present invention.

FIG. 8 is a perspective view of a disposable coffee-brewing device according to a second exemplary embodiment of the present invention.

FIG. 9 is an exploded perspective view of the disposable coffee-brewing device in FIG. 8.

FIG. 10 is a lateral sectional view of the disposable coffee-brewing device in FIG. 8.

FIG. 11 is a plan view of the disposable coffee-brewing device in FIG. 8.

FIGS. 12 to 14 are sectional views of a usage process of the disposable coffee-brewing device according to the second exemplary embodiment of the present invention.

FIG. 15 is a perspective view of a disposable coffee-brewing device according to a third exemplary embodiment of the present invention.

FIG. 16 is a lower perspective view of the disposable coffee-brewing device in FIG. 15.

FIG. 17 is a sectional view of the disposable coffee-brewing device in FIG. 15.

FIG. 18 is a perspective view of two stacked disposable coffee-brewing device according to the third exemplary embodiment of the present invention.

FIG. 19 is a sectional view of the disposable coffee-brewing device in FIG. 18.

FIG. 20 is a perspective view of the disposable coffee-brewing device supported by a beverage cup according to the third exemplary embodiment of the present invention.

FIG. 21 is a sectional view of the disposable coffee-brewing device in FIG. 20.

FIG. 22 is a sectional view of two stacked disposable coffee-brewing device in storage according to the third exemplary embodiment of the present invention.

### BEST MODE

Hereinafter, a disposable coffee-brewing device according to exemplary embodiments of the present invention will be described in detail with reference to accompanying drawings. In explaining the exemplary embodiments of the present invention, details of matters which are known to the skilled in the technical field such as known functions or configuration and are deemed to unnecessarily make technical nature of the present invention unclear will be omitted.

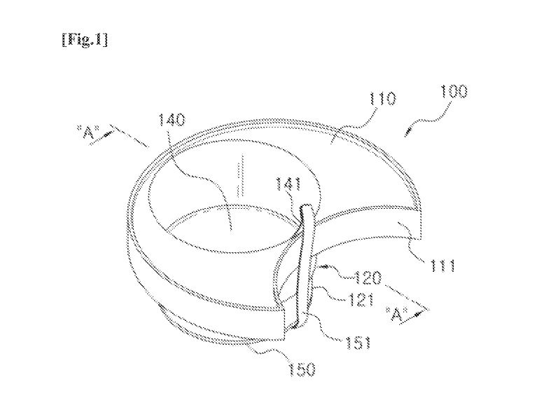

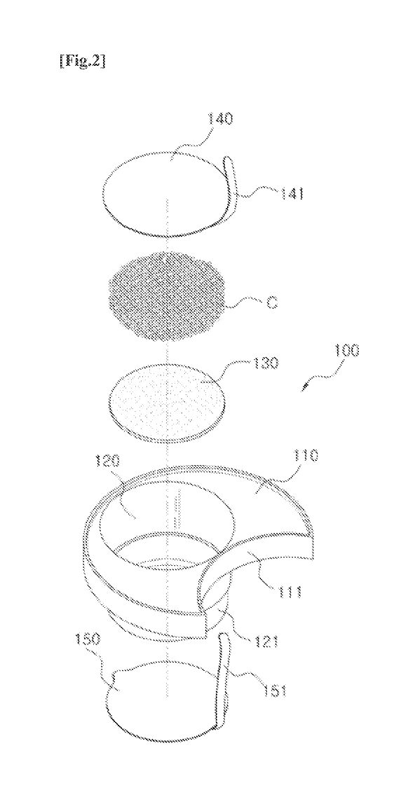

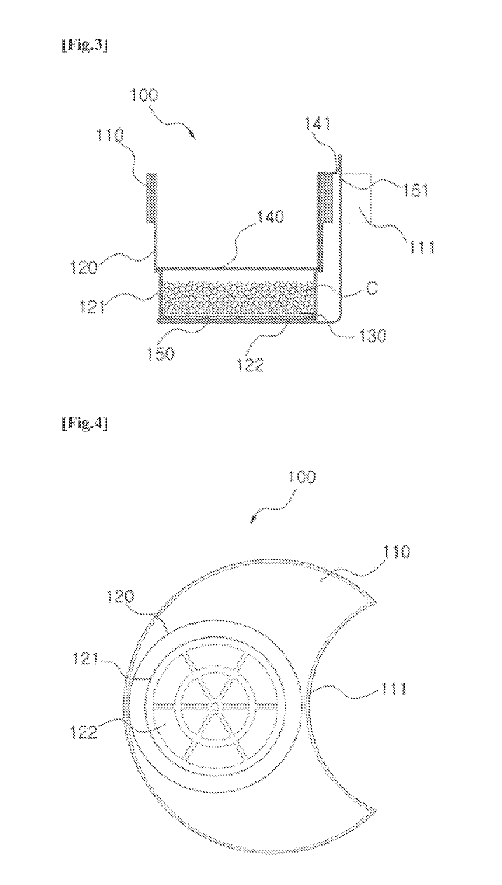

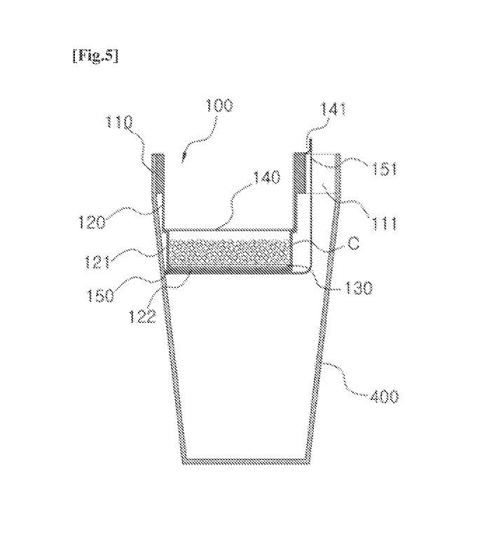

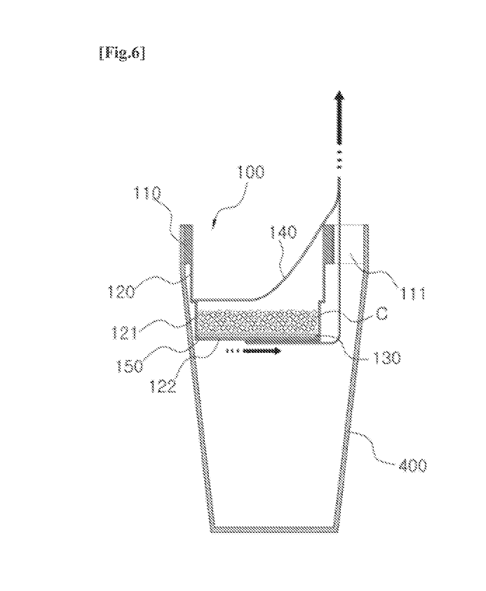

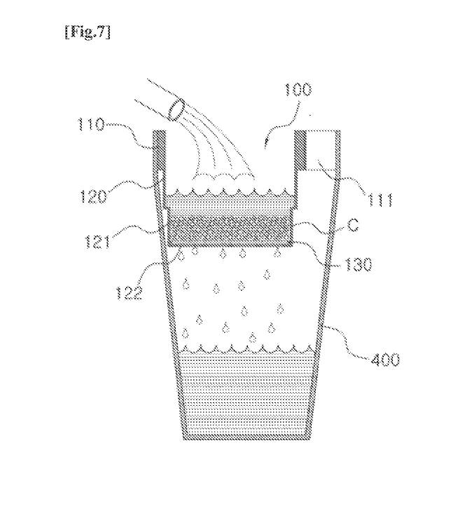

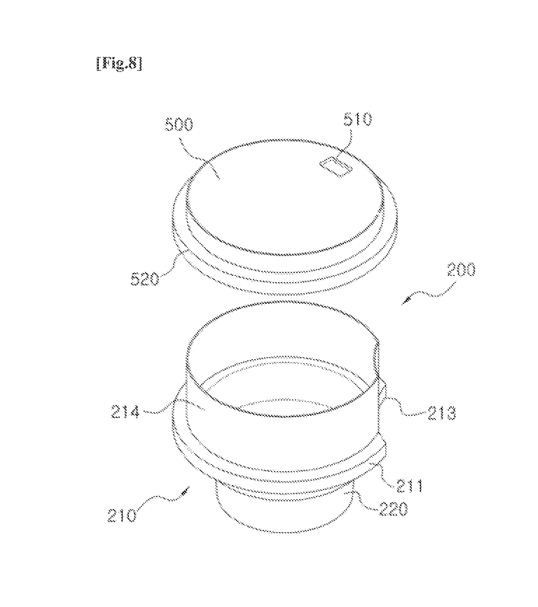

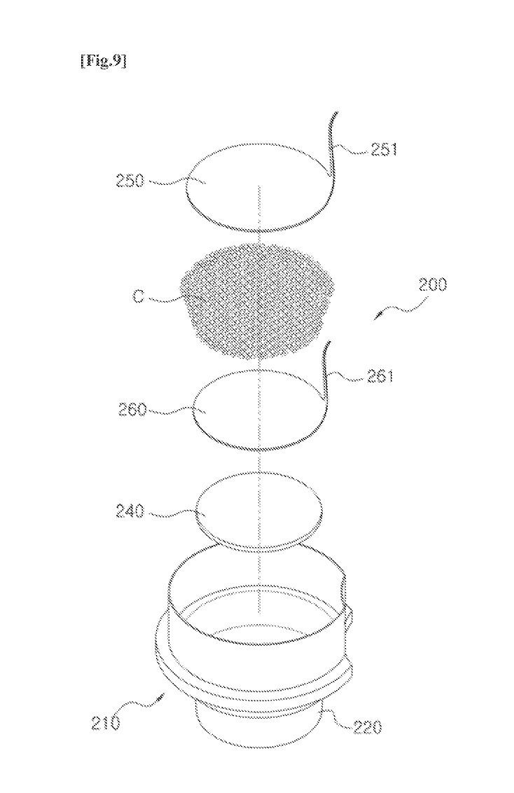

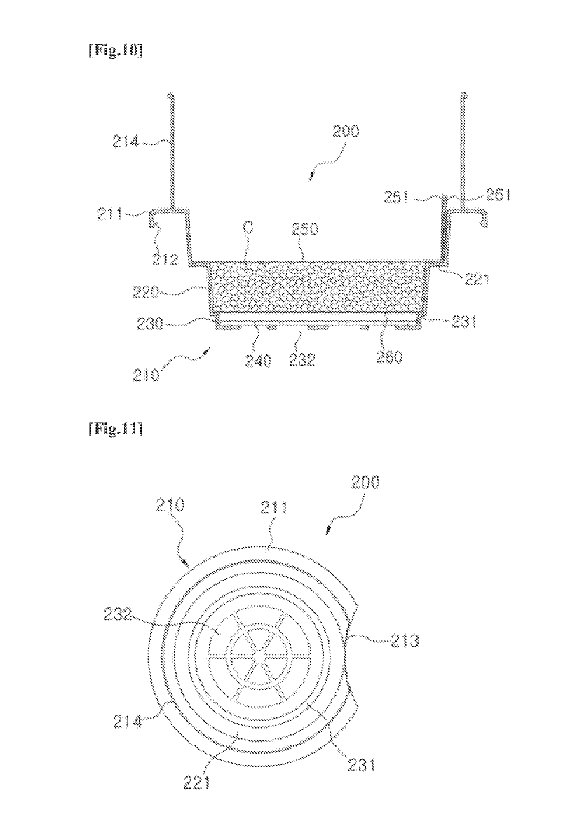

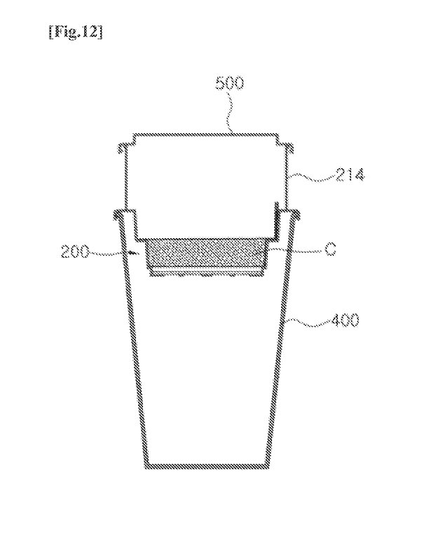

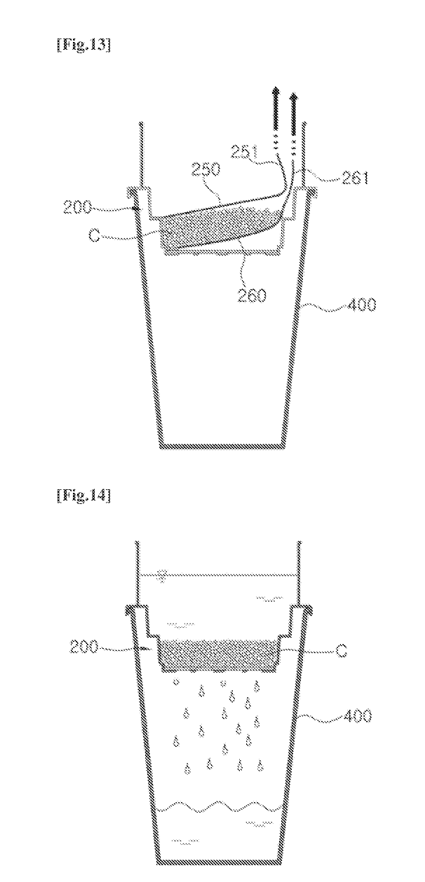

FIGS. 1 to 7 illustrate a disposable coffee-brewing device 100 according to a first exemplary embodiment of the present invention. FIG. 1 is a perspective view of the disposable coffee-brewing device 100 according to the first exemplary embodiment of the present invention. FIG. 2 is an exploded perspective view of the disposable coffee-brewing device 100 in FIG. 1. FIG. 3 is a sectional view of the disposable coffee-brewing device 100, taken along line “A-A” in FIG. 1. FIG. 4 is a plan view of a support plate 110 and a cylindrical body 120. FIGS. 5 to 7 are sectional views of a usage state of the disposable coffee-brewing device 100 according to the exemplary embodiment of the present invention.

Referring to FIGS. 1 to 7, the disposable coffee-brewing device 100 according to the first exemplary embodiment of the present invention includes a support plate 110, a cylindrical body 120, a filtering paper 130, an upper sealing cover 140 and a lower sealing cover 150.

The support plate 110 is detachably attached to a beverage container 400 such as a cup, and does not have any limitation in shape. Since most beverage containers 400 have a circular section, the support plate 110 preferably has a circular shape.

The coupling method of the support plate 110 with respect to the beverage container 400 is not limited specifically. The support plate 110 may forcedly be fitted to the inside of the beverage container 400 as shown in drawings, or the diameter of the support plate 110 may be larger than the beverage container 400 so that the support plate 110 may be stably seated on the top of the beverage container 400 or a step may be formed inside the beverage container 400 and the support plate 110 may be stably seated in the step.

An opening 111 which is cut in a predetermined size is preferably formed at one side of the support plate 110.

The opening 111 enables a user to easily detach the lower sealing cover 150 (which will be described later) provided in a lower side from the support plate 110 without separating the coffee-brewing device 100 according to the present invention from the beverage container 400 when the support plate 110 remains coupled to the beverage container 400.

The opening 111 may have various shapes, and may have, e.g., a semi-circular shape as shown in the drawings.

The cylindrical body 120 is integrally formed to protrude downwardly from the support plate 110, and is hollow and has a space therein to accommodate therein coffee grounds C.

A top of the cylindrical body 120 is open, and a coffee grounds-accommodating portion 121 is formed in a lower surface of the cylindrical body 120 to accommodate therein the coffee grounds C. The coffee grounds-accommodating portion 121 has a step to attach the upper sealing cover 140 (which will be described later) to a top thereof.

A brewing aperture 122 is formed in the bottom of the coffee grounds-accommodating portion 121 to downwardly brew the coffee liquid toward the beverage container 400.

The cylindrical body 120 may have a circular shape as show in the drawings, but not limited thereto. Alternatively, the cylindrical body 120 may have a rectangular shape.

The filtering paper 130 is attached to an upper surface of the brewing aperture 122 to filter water.

The upper sealing cover 140 is attached to the stepped top of the coffee grounds-accommodating portion 121, and the lower sealing cover 150 is attached to a bottom of the brewing aperture 122.

The upper and lower sealing covers 140 and 150 include a material to block air, and are attached to the top and the bottom of the coffee grounds-accommodating portion 121 as above to thereby maintain the coffee grounds-accommodating portion 121 in a sealing state.

As the coffee grounds-accommodating portion 121 is sealed, the coffee grounds C accommodated therein are blocked from the outside air and thus maintain its taste and flavor for a long time until the upper and lower sealing covers 140 and 150 are removed.

Preferably, handles 141 and 151 are formed in the upper and lower sealing covers 140 and 150 sealing the coffee grounds C to thereby remove such covers 140 and 150 without difficulty.

The handle 141 of the upper sealing cover 140 is formed to extend to the upper surface of the support plate 110, and the handle 151 of the lower sealing cover 150 is formed at one side of the lower sealing cover 150, farther from the opening 111. The handle 151 of the lower sealing cover 150 is preferably formed to extend to the upper surface of the support plate 110 through the opening 111.

The foregoing configuration is to easily remove the upper and lower sealing covers 140 and 150 without separating the coffee-brewing device 100 from the beverage container 400.

If the handle 151 of the lower sealing cover 150 extends to the upper surface of the support plate 110, a user may easily remove the lower sealing cover 150 from the brewing aperture 122 by pulling the handle 151 upward.

The handle 141 of the upper sealing cover 140 may be formed in either side of the upper sealing cover 140. The handle 141 may be formed at one side which is closer to the opening 111, and opposite ends of the handles 141 and 151 formed in the upper and lower sealing covers 140 and 150 are attached to each other as a single body to be pulled out at a time.

With the foregoing configuration, the usage method of the disposable coffee-brewing device 100 according to the first exemplary embodiment of the present invention is as simple as follows.

That is, as shown in FIG. 5, while the disposable coffee-brewing device 100 according to the present exemplary embodiment is coupled to the beverage container 400 such as a cup, the handles 141 and 151 of the upper and lower sealing covers 140 and 150 are pulled out to remove the upper and lower sealing covers 140 and 150 from the coffee grounds-accommodating portion 121 as shown in FIG. 6.

As the handles 141 and 151 of the upper and lower sealing covers 140 and 150 are attached to each other as a single body, a user may pull the end portions thereof to remove the covers 140 and 150.

If the upper and lower sealing covers 140 and 150 are removed, hot water is added to the cylindrical body 120 as shown in FIG. 7.

As above, the disposable coffee-brewing device 100 according to the first exemplary embodiment of the present invention has a simple process of removing the covers 140 and 150 and adding hot water. Until the covers 140 and 150 are removed, the coffee grounds C may be stored in a sealed state. Accordingly, the disposable coffee-brewing device 100 may be manufactured by being coupled to the beverage container 400 such as a disposable cup to be sold together with the beverage container 400, or only the disposable coffee-brewing device 100 may be manufactured and sold.

FIGS. 8 to 14 illustrate a disposable coffee-brewing device 200 according to a second exemplary embodiment of the present invention. FIG. 8 is a perspective view of the disposable coffee-brewing device 200 according to the second exemplary embodiment of the present invention. FIG. 9 is an exploded perspective view of the disposable coffee-brewing device 200 in FIG. 8. FIG. 10 is a lateral sectional view of the disposable coffee-brewing device 200 in FIG. 8. FIG. 11 is a plan view of the disposable coffee-brewing device 200 in FIG. 8. FIGS. 12 to 14 are sectional views of a usage state of the disposable coffee-brewing device 200 according to the second exemplary embodiment of the present invention. Hereinafter, the disposable coffee-brewing device 200 according to the second exemplary embodiment of the present invention will be described with reference to FIGS. 8 to 14.

Referring to FIGS. 8 to 14, the disposable coffee-brewing device 200 according to the second exemplary embodiment of the present invention includes a container main body 210 having a coffee grounds-accommodating portion 22 with a stepped portion therein and a brewing aperture formed in a bottom thereof, a filtering paper 240, an upper sealing cover 250 and a lower sealing cover 260.

The container main body 210 has an open top to accommodate coffee grounds C therein, and is coupled to a beverage container 400 such as a cup.

An elastic supporter 211 is preferably formed in an external circumference of the container main body 210, and has a shape that is bent downwardly, and includes a projection 212 protruding from and formed in an internal side thereof to be fitted to the beverage container 400 such as a cup.

A cutting portion 213 is preferably formed in an external circumference of the elastic supporter 211 of the container main body 210 to circulate air.

Preferably, a container extension portion 214 is formed in a ring shape along an upper surface of the elastic supporter 211 by extending in a predetermined length on the upper surface of the container main body 210. The container extension portion 214 extends upwardly from the container main body 210 to thereby extend the internal space of the container main body 210 and accommodate more hot water for brewing coffee.

A container lid 500 may be elastically fitted to the top of the container extension portion 214 wherever necessary. A cover supporter 520 with the same configuration as the elastic supporter 211 of the container main body 210 may be formed in a circumference of the container lid 500 and a straw hole 510 may be formed in an upper surface to connect a straw thereto.

The coffee grounds-accommodating portion 220 is provided between an upper step 221 formed in a location down from the top of the container main body 210 and an upper step 231 formed on the top of the brewing aperture 230, and accommodates therein the coffee grounds C.

The inside of the coffee grounds-accommodating portion 220 may have various shapes, but is preferably formed in a circular shape which does not cause any loss due to area, taking into account the nature of the coffee grounds-accommodating portion 220 mounted in a cup.

The brewing aperture 230 is provided in the bottom of the coffee grounds-accommodating portion 220 and is formed to have a step by the upper step 231, and a plurality of brewers 232 are formed in a certain shape such as a radial shape in a lower surface thereof.

The filtering paper 240 is fixed to the upper surface of the brewers 232 to filter the coffee grounds C and allows only the coffee liquid to pass therethrough. The filtering paper 240 is preferably larger than the area of the brewers 232.

The upper and lower sealing covers 250 and 260 are used to seal the coffee grounds-accommodating portion 220. The upper sealing cover 250 is attached to the upper step 221 of the coffee grounds-accommodating portion 220 and the lower sealing cover 260 is attached to the upper step 231 of the brewing aperture 230 to thereby completely seal the coffee grounds C accommodated in the coffee grounds-accommodating portion 220 from the outside air. The upper and lower sealing covers 250 and 260 may include various materials including an aluminum thin plate.

The lower sealing cover 260 is attached to the upper step 231 of the brewing aperture 230 and is spaced from the filtering paper 240 fixed to a bottom of the brewing aperture 230 at a predetermined interval. The upper step 231 is formed and the lower sealing cover 260 is spaced from the filtering paper 240 is because the filtering paper 240 is damaged or removed when the lower sealing cover 260 is removed in the case that the lower sealing cover 260 is closely adhered to the filtering paper 240.

Handles 251 and 261 may be formed at one side of the upper and lower sealing covers 250 and 260, respectively, to easily remove the upper and lower sealing covers 250 and 260 when a user drinks coffee. The handles 251 and 261 preferably extend in the same direction for convenience in use when a user drinks coffee.

With the foregoing configuration, the usage method of the disposable coffee-brewing device 200 according to the second exemplary embodiment of the present invention is as simple as follows.

As shown in FIG. 12, while the disposable coffee-brewing device 200 according to the present exemplary embodiment is coupled to a beverage container 400 such as a cup by fitting the elastic supporter 211 to the beverage container 400, the container lid 500 coupled to the container extension portion 214 is separated.

As shown in FIG. 13, the handles 251 and 261 of the upper and lower sealing covers 250 and 260 are pulled out to be removed from the coffee grounds-accommodating portion 220. The upper sealing cover 250 may be removed first and then subsequently the lower sealing cover 260 may be removed, or the upper and lower sealing covers 250 and 260 may be removed at the same time by gripping the handles 251 and 261.

After the upper and lower sealing covers 250 and 260 are removed, hot water is added to the container main body 210 and coffee is brewed as shown in FIG. 14.

If the coffee is brewed as above, the coffee-brewing device 200 according to the present exemplary embodiment is separated from the beverage container 400 and the container lid 500 is fitted to the beverage container 400 as necessary. Then, a user may put a straw through the straw hole 510 to drink coffee.

The disposable coffee-brewing device 200 according to the second exemplary embodiment of the present invention may brew coffee by a relatively simple process and store the coffee grounds C in a sealed state. Accordingly, the disposable coffee-brewing device 200 may be manufactured by being coupled to the beverage container 400 such as a disposable cup to be sold together with the beverage container 400, or may be solely manufactured and sold.

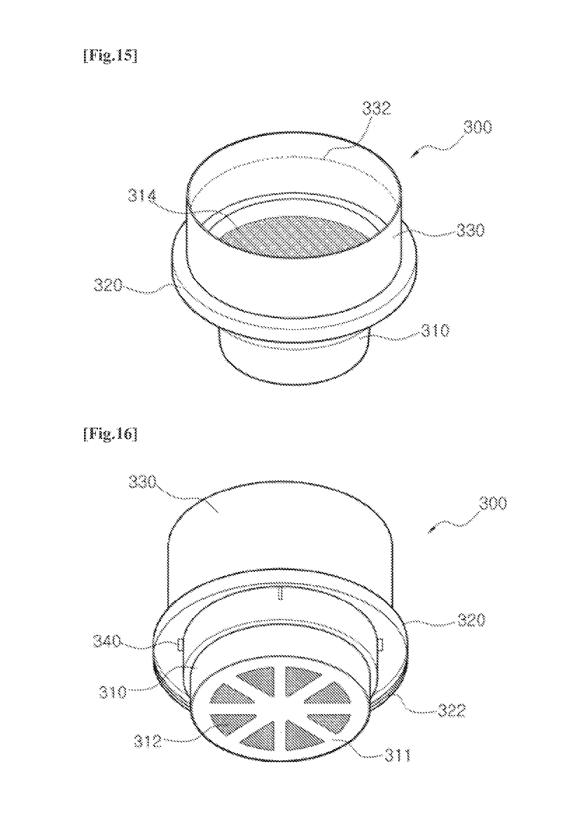

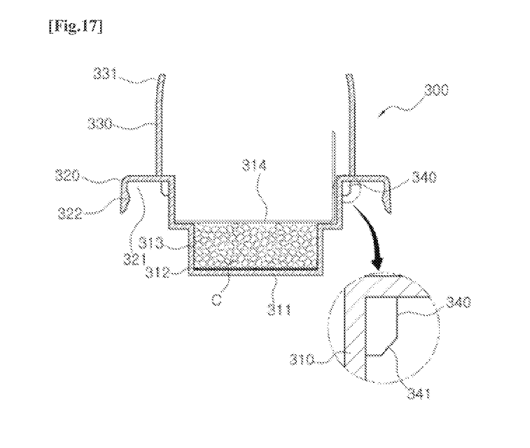

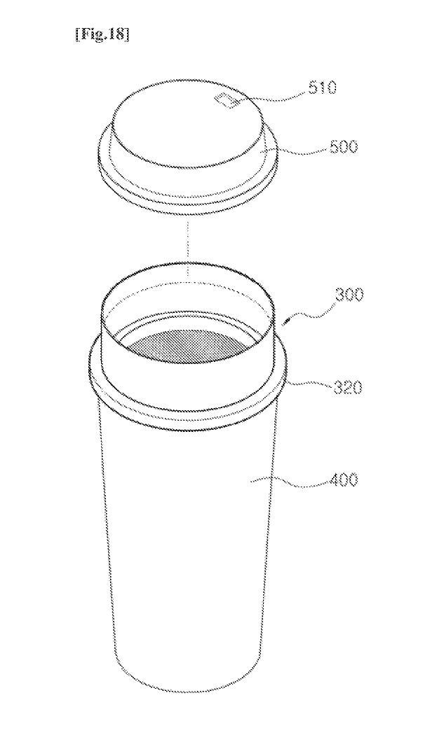

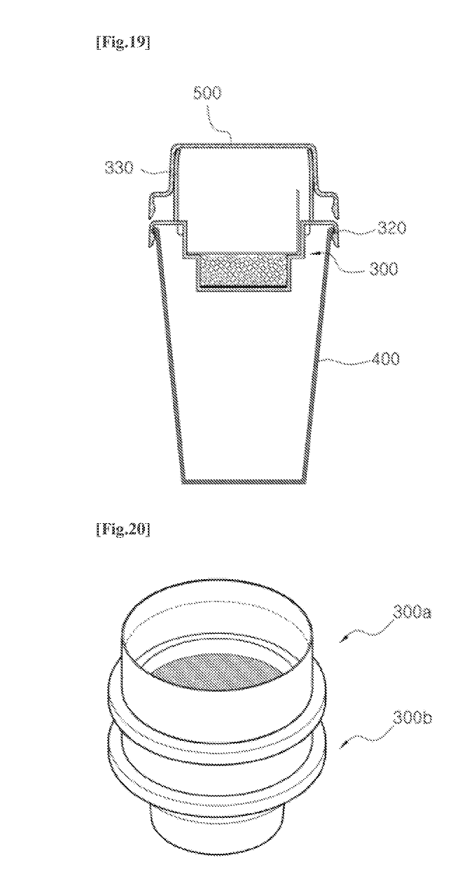

FIGS. 15 to 22 illustrate a disposable coffee-brewing device 300 according to a third exemplary embodiment of the present invention. FIG. 15 is a perspective view of the disposable coffee-brewing device 300 according to the third exemplary embodiment of the present invention. FIG. 16 is a lower perspective view of the disposable coffee-brewing device 300 in FIG. 15. FIG. 17 is a sectional view of the disposable coffee-brewing device 300 in FIG. 15. FIG. 18 is a perspective view of two stacked disposable coffee-brewing devices 300. FIG. 19 is a sectional view of the disposable coffee-brewing device 300 in FIG. 18. Hereinafter, the disposable coffee-brewing device 300 according to the third exemplary embodiment of the present invention will be described with reference to FIGS. 15 to 22.

Referring to FIGS. 15 to 19, the disposable coffee-brewing device 300 according to the third exemplary embodiment of the present invention includes a container main body 310 as a typical configuration.

The container main body 310 has a cylindrical shape, and has an open top and a brewing aperture 311 formed in a bottom thereof. A filtering paper 312 is attached and fixed to an upper surface of the brewing aperture 311. A coffee grounds-accommodating portion 313 is provided in an inside of the container main body 310, and coffee grounds C is accommodated and stored in the coffee grounds-accommodating portion 313.

A sealing cover 314 is attached to a top of the coffee grounds-accommodating portion 313 to seal the coffee grounds C. Such sealing cover 314 may also be attached to a bottom of the brewing aperture 311 for easy sealing.

With the foregoing configuration, a fitting supporter 320 is formed in an upper portion of the container main body 310 to support the beverage container 400.

The fitting supporter 320 is bent downwardly from an upper circumference of the container main body 310, and accordingly, a fitting space portion 321 is formed between an internal surface thereof and an external surface of the container main body 310 to insert the upper surface of the beverage container 400 thereinto.

A projection 322 protrudes from the internal surface of the fitting supporter 320 to hold the top of the beverage container 400 inserted into the fitting space portion 321.

When the container main body 310 having the foregoing configuration is supported by the beverage container 400, the fitting supporter 320 becomes elastically wider and enables the top of the beverage container 400 to be held by the projection 322 so as to stably support the container main body 310 by the beverage container 400 if the top of the beverage container 400 is inserted into the fitting space portion 321.

A container extension portion 330 may be formed in an upper portion of the container main body 310, and a plurality of fitting projections 340 may protrude from the external circumference of the container main body 310.

As shown in FIGS. 15 to 19, the container extension portion 330 has a cylindrical shape extending in a certain length upwardly from the upper surface of the container main body 310, and has an open top.

The container extension portion 330 may have a curved portion 331 which is curved in a central direction from a certain height toward the top so that the fitting projection 340 is fitted more firmly and elastically to the internal circumference.

The plurality of fitting projections 340 is formed in the external circumference of the container main body 310, but protrudes in a radial shape at a predetermined interval to be fitted to the internal circumference of the container extension portion 330. An inclination surface 341 may be formed in a lower surface of the fitting projections 340 to be easily fitted to the internal circumference of the container extension portion 330.

With the configuration of the container extension portion 330 and the fitting projections 340, the disposable coffee-brewing device 300 according to the present invention may be stacked in a pair into a layer.

As shown in FIGS. 18 and 19, the plurality of fitting projections 340 of the upper disposable coffee-brewing device 300a is elastically fitted to the internal circumference of the container extension portion 330 of the lower disposable coffee-brewing device 300b so that the two disposable coffee-brewing devices 300a and 300b are stably stacked into a layer.

If the plurality of disposable coffee-brewing devices is stably stacked into a layer without space, the various numbers of disposable coffee-brewing devices 300 may also be stacked to be sold to customers. That is, two disposable coffee-brewing devices 300 may be sold in a set for couples, and other various numbers of devices 300 may be sold for families, groups, etc.

The container extension portion 330 may have a diameter corresponding to the size of the container lid to be inserted into and fitted to the container lid 500. A water indication line 332 may be displayed at a certain height in an internal circumference of the container extension portion 330 to indicate the appropriate quantity of hot water.

With the foregoing configuration, the usage and storage of the disposable coffee-brewing device 300 according to the third exemplary embodiment of the present invention will be described.

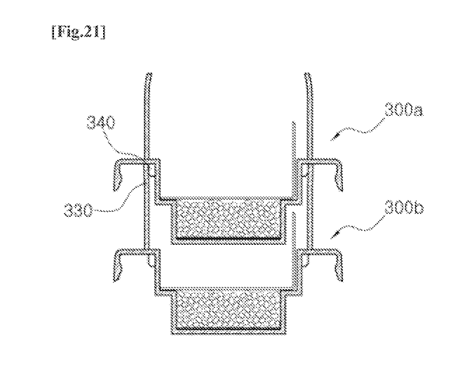

FIG. 20 is a perspective view of the disposable coffee-brewing device 300 supported by the beverage container 400 according to the third exemplary embodiment of the present invention. FIG. 21 is a sectional view of the disposable coffee-brewing device 300 in FIG. 20.

As shown in FIGS. 20 and 21, the disposable coffee-brewing device 300 according to the third exemplary embodiment of the present invention is supported with the fitting supporter 320 fitted to a top of the beverage container 400 and such device is stored with the container lid 500 of the beverage container 400 fitted to the container extension portion 330. Accordingly, the disposable coffee-brewing device 300, the beverage container 400 and the container lid 500 may be stably stored without any concern for separation.

If a user desires to drink coffee in the above state, he/she may separate the container lid 500 from the container extension portion 330, and remove the sealing cover 314 attached to the inside of the container main body 310 and add hot water.

The hot water may be added to the height of the water indication line 332 displayed in the internal circumference of the container extension portion 330 to thereby easily supply the appropriate quantity of hot water.

If the hot water is added, the coffee liquid is brewed by the brewing aperture 311 and stored in the beverage container 400. If the coffee liquid is completely brewed, the fitting supporter 320 is separated from the top of the beverage container 400 to decouple the disposable coffee-brewing device 300 from the beverage container 400.

After the disposable coffee-brewing device 300 is separated, the container lid 500 is fitted to the top of the beverage container 400 and a straw is put through a straw hole 510 of the container lid 500 to drink the stored coffee.

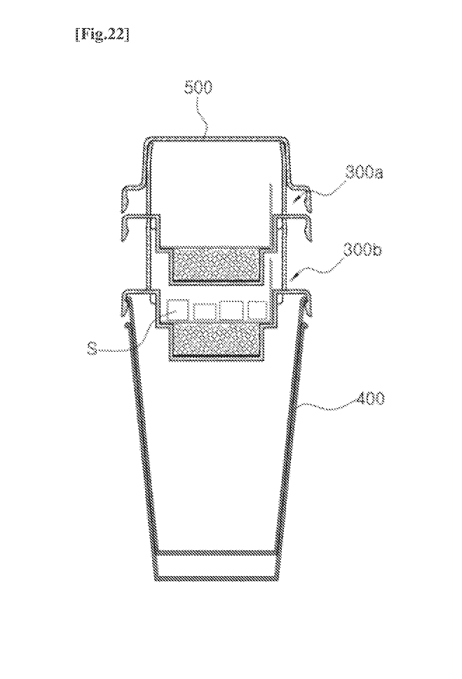

FIG. 22 illustrates two disposable coffee-brewing devices 300 stacked into a layer according to the third exemplary embodiment of the present invention. As shown therein, the fitting projections 340 of the upper coffee-brewing device 300a is fitted to the internal circumference of the container extension portion 330 of the lower coffee-brewing device 300b to thereby stably stack the two disposable coffee-brewing devices 300a and 300b into a layer without space.

If the disposable coffee-brewing devices are stored in a stacked layer, the fitting supporter 320 of the lower disposable coffee-brewing device 300b is fitted to the top of the beverage container 400, and the container lid 500 is fitted to the container extension portion 330 of the upper disposable coffee-brewing device 300a. The beverage container 400 is also stacked into a layer corresponding to the number of the stacked disposable coffee-brewing devices 300.

If a user drinks coffee in the above storage state, he/she may separate the stacked beverage containers 400 and the stacked disposable coffee-brewing devices 300a and 300b and add hot water like in the foregoing usage method to drink coffee with others.

Since the disposable coffee-brewing devices may plurally be stacked and stored stably, two disposable coffee-brewing devices may be provided as a couple set so that two people may drink coffee together.

If the disposable coffee-brewing devices are stacked and stored, the internal space may be used and thus additional goods such as lump sugar (s) may be stored in the inside of the disposable coffee-brewing device 300 as shown in FIG. 22 and utilization of space improves.

The disposable coffee-brewing device according to the exemplary embodiments of the present invention accommodates coffee therein, but not limited thereto. Alternatively, the disposable coffee-brewing device may accommodate green tea, black tea or other various beverage materials. Although a few exemplary embodiments have been shown and described, it will be appreciated by those skilled in the art that changes may be made in these exemplary embodiments without departing from the principles and spirit of the invention, the range of which is defined in the appended claims and their equivalents.

1. A disposable coffee-brewing device 100 comprising:
a support plate 110 which is coupled to a beverage container 400 such as a cup, and one side of which has an opening 111;
a cylindrical body 120 which protrudes downwardly from the support plate 110, and has an open top and a lower portion comprising a coffee grounds-accommodating portion 121 to accommodate therein coffee grounds C with a stepped portion and having a lower end with a brewing aperture 122 to which filtering paper 130 is attached; and
an upper sealing cover 140 and a lower sealing cover 150 which are attached to the top of the coffee grounds-accommodating portion 121 and to the bottom of the brewing aperture 122, respectively, to seal the coffee-grounds-accommodating portion 121, and which have respective handles 141 and 151, wherein
the handle 141 of the upper sealing cover 140 extends toward the upper surface of the support plate 110, and the handle 151 of the lower sealing cover 150 is formed at one side of the lower sealing cover 150, farther from the opening 111 and extends to the upper surface of the support plate 110 through the opening 111.

2. The disposable coffee-brewing device 100 according to claim 1, wherein end portions of the handles 141 and 151 of the upper and lower sealing covers 140 and 150 are attached to each other as a single body.

3. A disposable coffee-brewing device 200 comprising:
a container main body 210 which has an open top and a coffee grounds-accommodating portion 220 with a stepped portion to accommodate therein coffee grounds C in a location down from the open top at a certain distance, and a brewing aperture 230 with a plurality of brewers 232 in a bottom of the coffee grounds-accommodating portion 220;
a filtering paper 240 which is fixed to the top of brewers 232 of the brewing aperture 230;
an upper sealing cover 250 which is attached to an upper step 221 of the coffee grounds-accommodating portion 220 and seals the top of the coffee grounds-accommodating portion 220 and has a handle 251 extending from and formed at one side thereof; and
a lower sealing cover 260 which is attached to an upper step 231 of the brewing aperture 230 to be spaced from the filtering paper 240 at a predetermined interval and seals the bottom of the coffee grounds-accommodating portion 220 and has a handle 261 extending from and formed at one side thereof.

4. The disposable coffee-brewing device 200 according to claim 3, further comprising an elastic supporter 211 which is bent downwardly from an upper external circumference of the container main body 210 and has a projection 212 formed in an internal surface thereof and is elastically fitted to the top of the beverage container 400.

5. The disposable coffee-brewing device 200 according to claim 4, wherein a cutting portion 213 is formed at one side of the elastic supporter 211 to circulate air.

6. The disposable coffee-brewing device 200 according to claim 3, further comprising a container extension portion 214 which extends upwardly in a certain length along an upper section of the container main body 210.

7. A disposable coffee-brewing device 300 which accommodates and stores coffee grounds in an inside of a container main body 310 having an open top and a lower portion having a brewing aperture 311 to which filtering paper 312 is attached and brews coffee to a beverage container 400 by adding hot water, wherein
a fitting supporter 320 is bent downwardly from an upper circumference of the container main body 310 and forms a fitting space portion 321 between an internal surface thereof and an external surface of the container main body 310 to insert the upper surface of the beverage container 400 thereinto and has a step 322 formed in and protruding from an internal surface thereof.

8. The disposable coffee-brewing device 300 according to claim 7, further comprising a container extension portion 330 which extends in a certain length upwardly from the top of the container main body 310 and has an open top; and
a plurality of fitting projections 340 which protrudes from and is formed in an external circumference of the container main body 310 in a radial shape at a predetermined interval and is fitted to an internal circumference of the container extension portion 330, wherein
at least two disposable coffee-brewing devices 300 are stacked into a layer by fitting the fitting projections 340 of the upper disposable coffee-brewing device 300a to an internal circumference of the container extension portion 330 of the lower disposable coffee-brewing device 300b.

9. The disposable coffee-brewing device 300 according to claim 8, wherein an inclination surface 341 is formed in a lower surface of the fitting projections 340 and the container extension portion 330 has a curved portion 331 formed in an upper side thereof.

10. The disposable coffee-brewing device 300 according to claim 8, wherein the container extension portion 330 has a diameter corresponding to the size of the container lid 500 to be inserted into and fitted to the container lid 500 of the beverage container 400.

11. The disposable coffee-brewing device 300 according to claim 8, wherein a water indication line 332 is displayed in an internal circumference of the container extension portion 330 to adjust the quantity of hot water.
